(19) United States
(12) Patent Application Publication
(10) Pub. No.: US 2014/0176290 A1
(43) Pub. Date: Jun. 26, 2014

(54) MAGNETIC SHEET, METHOD FOR MANUFACTURING THE SAME, AND CONTACTLESS POWER TRANSMISSION DEVICE INCLUDING THE SAME

(71) Applicant: SAMSUNG ELECTRO-MECHANICS CO., LTD., Suwon (KR)

(72) Inventors: Jae Hyuk JANG, Suwon (KR); Yong Il KWON, Suwon (KR); Seung Min KIM, Suwon (KR); Kang Ryong CHOI, Suwon (KR)

(73) Assignee: SAMSUNG ELECTRO-MECHANICS CO., LTD., Suwon (KR)

(21) Appl. No.: 14/137,794

(22) Filed: Dec. 20, 2013

(30) Foreign Application Priority Data
Dec. 21, 2012 (KR) 10-2012-0150309

(51) Int. Cl. H01F 38/14; H01F 41/32

(52) U.S. Cl. CPC H01F 38/14; H01F 41/32
USPC 336/221; 156/60; 156/277; 428/457; 428/216; 428/448

(57) ABSTRACT

There is provided a method for manufacturing a magnetic sheet, including: preparing an insulation layer; preparing a laminate by forming a metal layer on the insulation layer; and laminating and compressing at least two laminates.

### CROSS-REFERENCE TO RELATED APPLICATIONS

This application claims the priority of Korean Patent Application No. 10-2012-0150309 filed on Dec. 21, 2012, in the Korean Intellectual Property Office, the disclosure of which is incorporated herein by reference.

### BACKGROUND

The present disclosure relates to a magnetic sheet, a method for manufacturing the same, and a contactless power transmission device including the same.

Research into a system for contactlessly transmitting power in order to charge the power in a secondary battery embedded in a portable terminal, or the like, has been recently conducted.

A contactless power transmission device may generally include a contactless power transmitter transmitting power and a contactless power receiver receiving and storing the power therein.

The contactless power transmission device may transmit and receive the power using electromagnetic induction. To this end, an inner portion of each of the contactless power transmitter and the contactless power receiver is provided with a coil.

A contactless power receiver configured of a circuit part and a coil part may be attached to a cellular phone case or an additional accessory tool in the form of a cradle to implement its function.

Describing an operational principle of the contactless power transmission device, household alternate current (AC) power supplied from the outside is input from a power supply unit of the contactless power transmitter.

The input household AC power is converted into direct current (DC) power by a power converting unit, is re-converted into AC voltage having a specific frequency, and is then provided to the contactless power transmitter.

When the AC voltage is applied to the coil part of the contactless power transmitter, a magnetic field around the coil part is changed.

As the magnetic field of the coil part of the contactless power receiver disposed to be adjacent to the contactless power transmitter is changed, the coil part of the contactless power receiver outputs power to charge the power in the secondary battery.

In the contactless power transmission device, a magnetic sheet may be positioned between a radio frequency (RF) antenna and a metal battery in order to increase a communication distance.

In the case of the related art, a soft magnetic metal powder, a metal magnetic material, is formed in a form of flake from a spherical shape using a milling machine, or the like, and is then formed in a sheet form using a dispersant and a resin.

The flake may have a thickness of 1 μm to 2 μm and a length of several tens to several hundreds micrometers.

In order to increase permeability of the magnetic sheet, a volume fraction and an aspect ratio of the flake need to be increased.

Therefore, it is required to manufacture a magnetic sheet having high permeability.

Patent Document 1 described in the following related art document relates to a laminated magnetic material. However, this Patent Document does not disclose a method for forming a thin metal layer such as in the present disclosure.

### RELATED ART DOCUMENT

(Patent Document 1) Japanese Patent Laid-Open Publication No. 2005-252187

### SUMMARY

An object of the present disclosure is to solve the defects in the related art.

By way of example, an aspect of the present disclosure may provide a magnetic sheet having increased permeability and a method for manufacturing the same.

In addition, another aspect of the present disclosure may provide a contactless power transmission device including the magnetic sheet having the increased permeability.

According to an aspect of the present disclosure, a method for manufacturing a magnetic sheet may include:

preparing an insulation layer; preparing a laminate by forming a metal layer on the insulation layer; and laminating and compressing at least two laminates.

The preparing of the laminate may be performed by a 3D printing method, but is not limited thereto.

The metal layer may have a thickness of 0.1 μm to 3.0 μm.

The insulation layer may be formed of a polymer, but is not limited thereto.

The insulation layer may be formed of a ceramic, but is not limited thereto.

The insulation layer and the metal layer may be attached to each other by inserting an adhesive layer therebetween.

According to another aspect of the present disclosure, a magnetic sheet may include: a plurality of metal layers; and an insulation layer disposed between the plurality of metal layers.

The metal layer may be formed by a 3D printing method.

The metal layer may have a thickness of 0.1 μm to 3.0 μm.

The insulation layer may be formed of a polymer, but is not limited thereto.

The insulation layer may be formed of a ceramic, but is not limited thereto.

The insulation layer and the metal layers may be attached to each other by inserting an adhesive layer therebetween.

According to another aspect of the present disclosure, a contactless power transmission device may include: a coil part; and a magnetic sheet formed on one surface of the coil part and including a plurality of metal layers and an insulation layer disposed between the plurality of metal layers.

The metal layer may be formed by a 3D printing method.

The metal layer may have a thickness of 0.1 μm to 3.0 μm.

The insulation layer may be formed of a polymer, but is not limited thereto.

The insulation layer may be formed of a ceramic, but is not limited thereto.

The insulation layer and the metal layers may be attached to each other by inserting an adhesive layer therebetween.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a flow chart schematically showing a method for manufacturing a magnetic sheet according to an exemplary embodiment of the present disclosure;

FIG. 2 is a perspective view schematically showing a magnetic sheet according to an exemplary embodiment of the present disclosure; and

FIG. 3 is an exploded perspective view schematically showing a contactless power transmission device according to another exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Hereinafter, exemplary embodiments of the present disclosure will be described in detail with reference to the accompanying drawings. Meanwhile, in describing the present exemplary embodiment, a contactless power transmission device generally includes a contactless power transmitter transmitting power and a contactless power receiver receiving and storing the power therein.

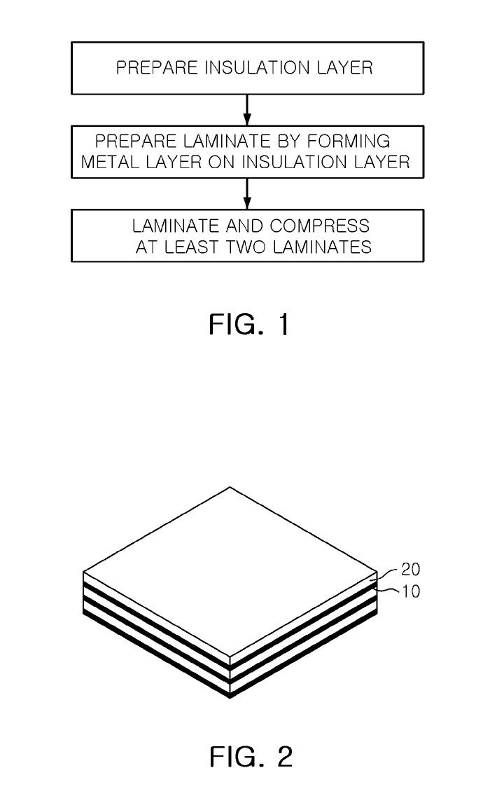

FIG. 1 is a flow chart schematically showing a method for manufacturing a magnetic sheet according to an exemplary embodiment of the present disclosure and FIG. 2 is a perspective view schematically showing a magnetic sheet according to an exemplary embodiment of the present disclosure.

Referring to FIGS. 1 and 2, the method for manufacturing the magnetic sheet according to the exemplary embodiment of the present disclosure may include preparing an insulation layer 10, preparing a laminate by forming a metal layer 20 on the insulation layer 10, and laminating and compressing at least two laminates.

In order to increase permeability of the magnetic sheet, a volume fraction and an aspect ratio of a flake used in the related art need to be increased.

Among these, in the case in which the aspect ratio converges to infinity, the flake has an infinitely wide thin film form.

Therefore, the magnetic sheet according to the exemplary embodiment of the present disclosure may be formed of the metal layer 20 having a very small thickness.

By way of example, the metal layer 20 may have the thickness of 0.1 μm to 3.0 μm.

In the case in which the metal layer 20 has a thickness less than 0.1 μm, it may not be substantially operated as a magnetic sheet. In the case in which the metal layer 20 has a thickness greater than 3.0 μm, the thickness of the metal layer is excessively large, such that compatibility may be degraded.

Therefore, in the case in which the metal layer 20 has a thickness of 0.1 μm to 3.0 μm, effects such as an increase in a communications distance and an increase in efficiency of the contactless power transmission device may be obtained, and compatibility may also be secured.

According to the exemplary embodiment of the present disclosure, the preparing of the laminate may be performed by a 3D printing method, but is not limited thereto.

The 3D printing means that a fine metal film or a metal pattern is formed on a plastic or a polymer substrate only by a screen printing method, without using an existing lithography technology.

This may be enabled by printing a nanoparticle paste formed of a metal such as gold, silver, pure iron, or ferrite, or an alloy thereof using an ink-jet technology.

Main components of the metal nanoparticle paste be metal nanoparticles having an average particle size of several to several tens nanometers (nm) and having a narrow particle size distribution.

The paste may be manufactured by adjusting a content, a viscosity, and the like of metal.

A conductive film capable of being obtained by applying the metal nanoparticle paste using the 3D printing method and firing the paste may have properties similar to specific resistance of a bulk metal.

Therefore, the metal layer 20 according to the exemplary embodiment of the present disclosure is formed by the 3D printing method using the metal nanoparticle paste, such that the thickness of the metal layer 20 may be very small and the properties of the metal layer 20 may be similar to those of the bulk metal layer.

Since the properties of the bulk metal layer may be maintained by increasing the aspect ratio of the metal layer 20, the permeability of the metal layer may be increased.

The insulation layer 10 may be disposed between the metal layers 20 to insulate the respective metal layers 20 from each other in the laminate.

The thickness of the insulation layer 10, a thickness capable of realizing at least a sufficient amount of insulation between the metal layers 20, may be formed as thin as possible.

The thickness of the insulation layer 10 is thinly formed, such that processing costs may be decreased.

A material of the insulation layer 10 may be a polymer or a ceramic, but is not limited thereto.

Since the magnetic sheet may provide a path for emitting heat from the contactless power transmission device, the material of the insulation layer 10 may be a material having excellent heat conductivity.

The material of the insulation layer 10 may be epoxy having excellent heat conductivity and excellent insulating properties.

In the case in which the insulation layer 10 is formed of a ceramic, adhesive properties thereof with the metal layer may be decreased.

Therefore, the insulation layer 10 and the metal layer 20 may be attached to each other by inserting an adhesive layer (not shown) therebetween.

The adhesive layer may be a polymer, and may be epoxy having excellent heat conductivity and excellent insulating properties.

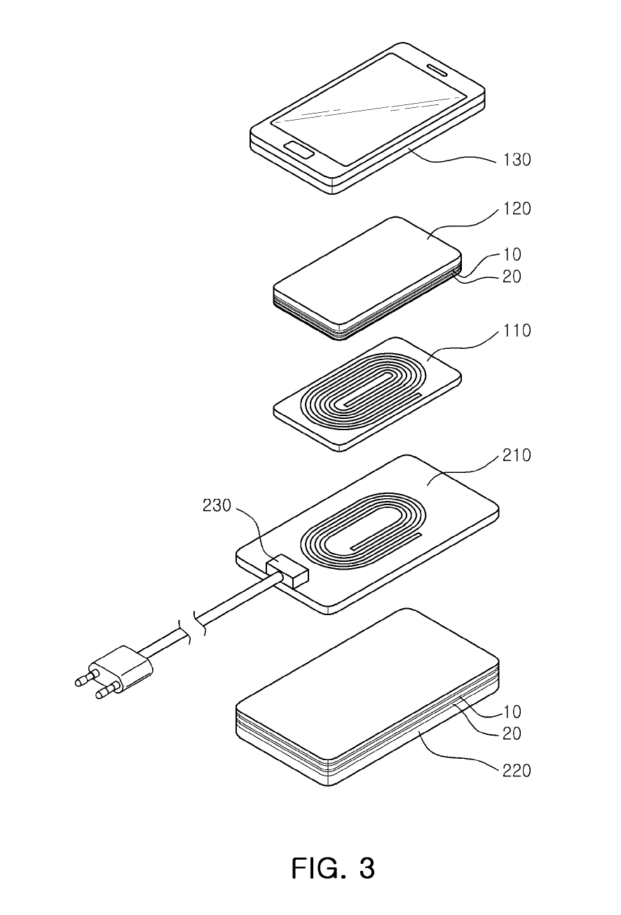

FIG. 3 is an exploded perspective view schematically showing a contactless power transmission device according to another exemplary embodiment of the present disclosure.

Referring to FIG. 3, the contactless power transmission device according to another exemplary embodiment of the present disclosure may include coil parts 110 and 210; and magnetic sheets 120 and 220 each formed on one surface of the coil part 110 or 210 and including a plurality of the metal layers 20 and the insulation layer 10 disposed between the plurality of metal layers 20.

The coil parts 110 and 210 of the contactless power transmission device may be provided in the form of a wiring pattern on the substrate and may form a single coil pattern in which a single coil is continuously connected or a plurality of coil strands are connected in parallel to one another.

The coil parts 110 and 210 may be manufactured in a winding form or be manufactured in a flexible film form, but are not limited thereto.

The coil parts 110 and 210 transmit power input from a power input unit 230 using an induced magnetic field or receive the induced magnetic field to allow the power to be output, thereby enabling contactless power transmission.

As described above, the contactless power transmission device may charge an electronic device 130 and the like by transmitting and receiving the induced magnetic field, while being spaced apart from the electronic device 130 and the like by a predetermined distance.

The charging efficiency of the contactless power transmission may be determined depending on an amount of a flow of changing magnetic flux per hour based on Faraday's law.

In this case, in order to increase permeability, the magnetic sheet having high permeability may be used.

The magnetic sheets 120 and 220 may serve to increase the charging efficiency of the contactless power transmission device.

The magnetic sheets 120 and 220 may focus the induced magnetic field to a desired direction within the minimum thickness thereof in order to secure compatibility, such that an influence on a circuit, a battery, and the like of the electronic device 130 caused by the induced magnetic field may be significantly reduced.

In addition, at the time of the contactless power transmission, the magnetic sheets 120 and 220 may provide a path in which the induced magnetic field passing through the magnetic sheets 120 and 220 may discharge heat generated due to eddy loss, in the magnetic sheets 120 and 220.

As set forth above, according to the exemplary embodiments of the present disclosure, the defects in the related art may be solved.

By way of example, according to the exemplary embodiments of the present disclosure, the metal layer is formed of a thin film, such that permeability of the magnetic sheet may be improved.

In addition, the contactless power transmission device including the magnetic sheet having improved permeability and thus, allowing for an increased transmission distance, may be provided.

While exemplary embodiments have been shown and described above, it will be apparent to those skilled in the art that modifications and variations could be made without departing from the spirit and scope of the present disclosure as defined by the appended claims.

What is claimed is:

1. A method for manufacturing a magnetic sheet, the method comprising:
preparing an insulation layer;
preparing a laminate by forming a metal layer on the insulation layer; and
laminating and compressing at least two laminates.

2. The method of claim 1, wherein the preparing of the laminate is performed by a 3D printing method.

3. The method of claim 1, wherein the metal layer has a thickness of 0.1 μm to 3.0 μm.

4. The method of claim 1, wherein the insulation layer is formed of a polymer.

5. The method of claim 1, wherein the insulation layer is formed of a ceramic.

6. The method of claim 5, wherein the insulation layer and the metal layer are attached to each other by inserting an adhesive layer therebetween.

7. A magnetic sheet, comprising:
a plurality of metal layers; and
an insulation layer disposed between the plurality of metal layers.

8. The magnetic sheet of claim 7, wherein the metal layer is formed by a 3D printing method.

9. The magnetic sheet of claim 7, wherein the metal layer has a thickness of 0.1 μm to 3.0 μm.

10. The magnetic sheet of claim 7, wherein the insulation layer is formed of a polymer.

11. The magnetic sheet of claim 7, wherein the insulation layer is formed of a ceramic.

12. The magnetic sheet of claim 11, wherein the insulation layer and the metal layers are attached to each other by inserting an adhesive layer therebetween.

13. A contactless power transmission device, comprising:
a coil part; and
a magnetic sheet formed on one surface of the coil part and including a plurality of metal layers and an insulation layer disposed between the plurality of metal layers.

14. The contactless power transmission device of claim 13, wherein the metal layer is formed by a 3D printing method.

15. The contactless power transmission device of claim 13, wherein the metal layer has a thickness of 0.1 μm to 3.0 μm.

16. The contactless power transmission device of claim 13, wherein the insulation layer is formed of a polymer.

17. The contactless power transmission device of claim 13, wherein the insulation layer is formed of a ceramic.

18. The contactless power transmission device of claim 17, wherein the insulation layer and the metal layers are attached to each other by inserting an adhesive layer therebetween.
